(19) United States
(12) Patent Application Publication
(10) Pub. No.: US 2007/0211462 A1
(43) Pub. Date: Sep. 13, 2007

(54) Accessory attachment apparatus

(76) Inventors: Robbie A. Dowell, Corona, CA (US); Diane M. Dowell, Corona, CA (US)

Correspondence Address: STETINA BRUNDA GARRED & BRUCKER, 75 ENTERPRISE, SUITE 250, ALISO VIEJO, CA, 92656, US

(21) Appl. No.: 11/511,105

(22) Filed: Aug. 28, 2006

Related U.S. Application Data
(60) Provisional application No. 60/780,357, filed on Mar. 7, 2006.

(51) Int. Cl. F21V 21/00

(52) U.S. Cl. 362/249

(57) ABSTRACT

An accessory attachment apparatus for removably mounting an accessory to a structure is disclosed. The accessory has a coupling member of a first size. The device includes an elongate member defined by a base segment, and a pair of opposed coupling segments. The coupling segments may each include a gripping portion for frictionally and releasably engaging the coupling member between such opposed coupling segments.

### CROSS-REFERENCE TO RELATED APPLICATIONS

This application relates to and claims the benefit of U.S. Provisional Application No. 60/780,357 filed Mar. 7, 2006 and entitled SNAP ON, SNAP OFF, THE SNAPPER which is incorporated by reference herein.

### STATEMENT RE: FEDERALLY SPONSORED RESEARCH/DEVELOPMENT

Not Applicable

### BACKGROUND

1. Technical Field

The present invention generally relates to devices for supporting decorative articles or other equipment mounted on buildings and other structures. More particularly, the present invention relates to building-mounted devices that interchangeably engage ornamental articles and other accessories.

2. Related Art

During holidays, birthdays, anniversaries, and other celebratory occasions, it is common practice to decorate homes, offices, and other such buildings to create a festive ambiance. Many types of building decorations are known in the art, but perhaps the most popular is the decorative light string, which includes multiple electric lamps and sockets spaced apart along an electrical cord. In the United States, the most common holiday for which the decorative light string is used is Christmas. However, the use of light strings to decorate for Valentine's Day, Easter, St. Patrick's Day, Independence Day, Halloween, and Thanksgiving are all gaining popularity. A number of variations exist, such as the icicle light string, where multiple strands of smaller electrical cord with lamps and sockets attached thereto are spaced along a main electrical cord. The decorative light strings may be used indoors, with attachment to window frames, doorways, walls, and so forth. Additionally, the light strings may be used to trim exterior building edges such as eaves, rain gutters, awnings, roofs, patio covers, block walls, garage doors and the like. Generally, the light strings are positioned to outline architectural features of the building or structure to which it is attached. Illuminating the exterior has been believed to provide a sense of warmth and comfort, particularly during the cold winter months that mark the holiday season. In addition to light strings, other hanging accessories may be used in combination to create a particular ornamental theme.

Due to the desirable decorative results, conventional attachments of decorative accessories continue despite numerous deficiencies. Typically, light strings are directly attached to buildings with connectors such as staples, nails, screws, hooks and the like. As will be appreciated, these attachment methods result in considerable damage to the underlying structure, and compounding the problem is the necessity to remove the unsightly accessories after the end of the season. Not only does the structure experience greater wear and tear in conventional attachments, the electrical cord is likely to fray. This may result in displacement of the light strings, and possible electrical hazards to a bystander or decorator during installation. Along these lines, certain installations may require the decorator to work at unsafe heights, with the danger being compounded with repeated hammering or screwing in of fasteners. Despite the decorator taking a significant risk by being exposed to all of these dangers, the results may be unsatisfactorily crooked due to the cumbersome installation procedure associated with long light strings. Further, with all of the labor involved, it may become necessary to retain professionals to complete the installation, albeit at a significantly increased cost.

As a consequence of the aforementioned deficiencies, decorators are often inclined to leave the lights in place upon attachment. Although this avoids yearly installation and removal, the strings of lights are exposed to weather, resulting in early deterioration. While the light strings are unlikely to be visible during nighttime so long as they are not connected to an electrical source or otherwise turned on, during the daytime in the off-season, they add nothing to, and in fact detract from, the appearance of the building.

A number of devices have been proposed to overcome the above-noted deficiencies in the art. One device is disclosed in U.S. Pat. No. 3,692,993 to Robinson, which teaches a lighting fixture having a housing adapted to be mounted on a building. The housing includes an opening in a wall on which a door is mounted. The door includes a plurality of light bulbs, and may be rotated out to an extended position to expose the light bulbs, and rotated back in to a retracted position to hide the light bulbs. While alleviating some deficiencies, namely, the need for the decorator to repeatedly attach and remove light strings season after season, and the capability of hiding the light-bulbs during the off-season, the Robinson device still exposes the light bulbs to temperature-related stresses in outdoor applications. As can be appreciated, such limitations arise from the cumbersome mechanism by which the individual light bulbs are attached to the door. Specifically, the light bulbs were inserted through pre-set bulb engagement holes defined by the door, and also required elaborate basket-type holding mechanisms that retained the bulb in the engagement holes. Since the engagement holes were spaced in a predetermined configuration, customization of the density of the light bulbs in particular sections is typically not possible. Accordingly, the illumination characteristics may be too lifeless and unexciting, since the lighting was pre-arranged. Although it is possible for the engagement holes to be placed randomly, the arrangement and density of the light bulbs is largely dependent on surroundings and the decorator's personal taste, and thus such an option is of limited utility. Another deficiency is that adding and removing the light strings appear to be just as difficult and dangerous as prior art devices, particularly when attached to buildings at increased heights. An option is to remove the entire device from the building, which is no better a solution than existing prior art as indicated above.

Certain alternative constructions are disclosed in U.S. Pat. No. 5,594,628, to Reuter et al., A Decorative Exterior Lighting System. The Reuter et al. device includes an upper rail hingably attached to a lower rail. The upper rail holds a series of decorative light bulbs in a pre-set linear arrangement. In an open configuration, the light bulbs are exposed, and in a closed position, the light bulbs are hidden within the lower rail. The device may serve as a decorative trim piece in the closed position. Like the Robinson device, however, the Reuter et al. device prevents the quick and easy removal of the light bulbs therefrom. Accordingly, the attendant deficiencies as described above still remained.

Another assembly for the removal and attachment of decorative light strings is the two-piece construction disclosed in U.S. Pat. No. 6,033,088 to Contigiani. Specifically, Contigiani discloses a lighting assembly having a first perforated member adapted to receive bulbs of a light string. The perforations are such that the sockets of the light strings can be compressively retained therein. A separate support member is coupled with the perforated member. The support member can be attached to the building. The perforated member, including the light string, con be readily attached to and removed from the support member. The Contigiani device eliminates the need to remove the entire unit from the structure, and taking down the lights for the season can be accomplished in one step. However, the inability to arrange the light bulbs in a dynamic fashion remains, since the perforations are pre-arranged.

Accordingly, there is a need in the art for improved building-mounted devices that interchangeably engage ornamental accessories that overcome the deficiencies in the art as set forth above. More specifically, there is a need in the art for accessory attachment devices that reduces electrocution and other dangers to the decorator during installation. Furthermore, there is a need in the art for such accessories to be attached to buildings in any desirable density or other configuration style. There is also a need in the art for the accessories to be readily detachable from the structure.

### BRIEF SUMMARY

In accordance with one aspect of the present invention, there is provided a device for removably mounting an accessory to a structure. The accessory may have a coupling member of a first size. The device may include an elongate member defining a base segment and a pair of opposed, resilient coupling segments. The coupling segments may each include a gripping portion for frictionally and releasably engaging the coupling member of the accessory therebetween.

In another aspect of the present invention, the base segment and the pair of coupling segments define a channel therebetween. The channel may extend along a longitudinal axis of the elongate member. The elongate member may further define an open end of the channel for engagement of the accessory therethrough. It is understood that the accessory may be engaged to the elongate member along an axis perpendicular to the longitudinal axis. Further, a first one of the coupling segments and a second one of the coupling segments may extend from the base segment. The base segment may define a first lateral edge and a second lateral edge, with the first one of the coupling segments extending from the first lateral edge and the second one of the coupling segments extending from the second lateral edge. The base segment may define a plurality of fastener apertures for receiving a fastener to fix the first elongate member to the structure.

In yet another aspect of the present invention, the device may include a cover engageable to the first and second coupling segments on the elongate member. In this regard, the first and second coupling segments may each define a notch to which the cover is engageable. The cover may be slidably engageable to the coupling segments along an exterior surface thereof. Additionally, the cover may be resiliently deformable for frictional engagement to the elongate member. The coupling segments of the elongate member may be resiliently deformable for frictional engagement to the cover.

According to another aspect of the present invention, the device may also include a secondary adapter capable of being disposed within the elongate member. The secondary adapter may be defined by an adapter base and a pair of opposed adapter arms conforming to the contour of the coupling segments of the elongate member. The secondary adapter and the elongate member may be coupled to the structure with fasteners.

In another preferred embodiment of the present invention, there is provided an accessory mounting device. The device may include an elongate rail of unitary construction. The elongate rail may define an internal conduit bounded by a rear wall, a first leg, and a second leg. The first and second legs may each include an accessory engagement portion. The accessory engagement portion may define a truncated v-shaped cross section.

A number of accessories may be mounted to the accessory mounting device in accordance with the preferred embodiment. The accessory may be a light string with a plurality of light bulbs mated to sockets of the C7 size, or of the C9 size. Alternatively, the accessory may be a misting apparatus with a main line extending through the internal conduit and in fluid communication with a pressurized water source. In such a misting apparatus, the main line may be in fluid communication with a plurality of mist nozzles via connecting tubes. Furthermore, there may also be provided a plurality of hooks extending from the first leg in a spaced relationship. The accessory may also be a hook insert having an elongate main body and a hook extending therefrom. The main body may have a cross section substantially contoured to that of the internal conduit.

According to yet another preferred embodiment of the present invention, there is provided a decorative lighting assembly for providing an illumination effect to a building. The assembly may include a light string having a plurality of light bulbs mated to electrically interconnected sockets. The assembly may further include an elongate member with a trough defined by a pair of opposed coupling elements for frictional engagement of the sockets. At least a portion of the coupling elements may define a truncated v-shaped cross section. The coupling elements may be adapted to receive and slidably engage at least one socket of the light string. The sockets may be spaced along a wire engageable to a power source. The wire may be hidden behind the coupling element inside the trough. The coupling elements may further be biased towards each other, thereby increasing the gripping force upon the socket. The elongate member may be constructed of material that can be cut to vary the length thereof.

In still another preferred embodiment of the present invention, a misting assembly for supplying hydration to areas surrounding a structure is provided. The misting assembly may include a mister, which may additionally include a main a main line in fluid communication with a source, a nozzle in fluid communication with the main line, and an enclosure housing the main line. The enclosure may an access port through which the nozzle extends from the main line. The misting assembly may also include an elongate member having a trough defined by a pair of opposed coupling elements for frictional engagement of the mister. At least a portion of the coupling elements may define a truncated v-shaped cross section. The enclosure of the mister may define a cross section corresponding to the trough, the mister being retained therein.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a first accessory attachment apparatus with a light string attached thereto in accordance with one aspect of the present invention;

FIG. 2 is a cross sectional view of the first accessory attachment apparatus fixed to a structure, taken along axis 2-2 of FIG. 1;

FIG. 3 is a cross sectional view of a second accessory attachment apparatus disposed within the first accessory attachment apparatus in accordance with another aspect of the present invention;

FIG. 3A is a cross sectional view of the second accessory attachment apparatus disposed within the first accessory attachment apparatus, with a fastener securing both the first and second accessory attachment apparatuses to the structure;

FIG. 4 is a perspective view of an icicle light string accessory suspended from hooks on the first accessory attachment apparatus;

FIG. 5 is a cross sectional view of the first accessory attachment apparatus with the icicle light string accessory suspended from hooks, taken along axis 5-5 of FIG. 4;

FIG. 5A is a cross sectional view of the first accessory attachment apparatus with an insert including hooks for suspending additional accessories.

FIG. 6 is a cross sectional view of the first accessory attachment apparatus with a first misting apparatus in accordance with an aspect of the present invention;

FIG. 7 is a cross sectional view of the first accessory attachment apparatus with a second misting apparatus;

FIG. 8 is perspective view of a first accessory attachment apparatus including a cover of a first type with an ornamental face;

FIG. 9 is a cross sectional view of the first accessory attachment apparatus with the cover of the first type, taken along axis 9-9 of FIG. 8; and

FIG. 10 is a cross-sectional view of the first accessory attachment apparatus with the cover of a second type in accordance with an aspect of the present invention.

Common reference numerals are used throughout the drawings and the detailed description to indicate the same elements.

### DETAILED DESCRIPTION

The detailed description set forth below in connection with the appended drawings is intended as a description of the presently preferred embodiment of the invention, and is not intended to represent the only form in which the present invention may be constructed or utilized. It is understood that the use of relational terms such as first and second, top and bottom, and the like are used solely to distinguish one from another entity without necessarily requiring or implying any actual such relationship or order between such entities.

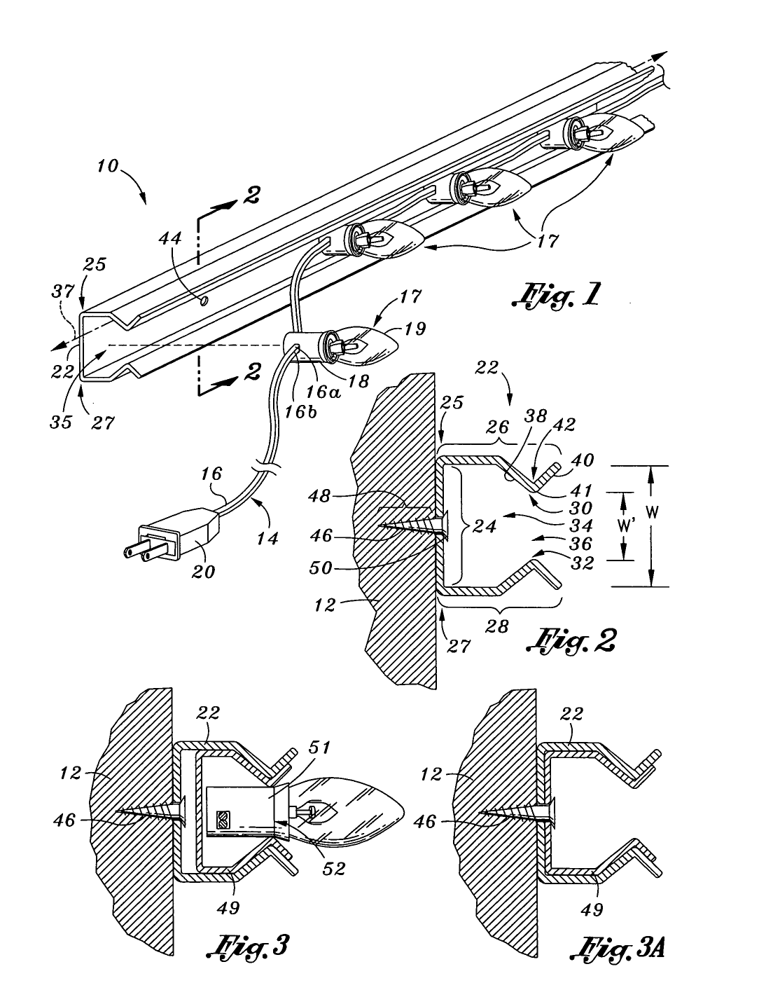

With reference to FIGS. 1 and 2, a preferred embodiment of an accessory attachment apparatus 10 is permanently attached to a structure 12. As indicated above, accessories may be attached to a variety of structures and parts thereof, such as roofs, awnings, walls, eaves, and so forth, to enhance its decorative appearance. Accordingly, it will be understood that the present invention need not be limited to attachment to any particular structure, orientation or material, and the use of the apparatus 10 for decorating any other desirable location is deemed to be within the inventive scope.

In the particular illustrated embodiment, an exemplary accessory, a light string 14, is coupled to the apparatus 10. As will be further illustrated below, the light string 14 is presented by way of example only and not of limitation, so any accessory capable of being coupled to the apparatus 10 in the manner described herein may be readily substituted. The light string 14 is comprised of an electrical cable 16, with sockets 18 electrically connected thereto. Light bulbs 17 are mated to the respective one of the sockets 18, and may be variously colored for enhanced thematic effect. The light bulbs 17 are conventionally of the incandescent type, but light emitting diodes (LEDs) types are also known in the art. One end of the electrical cable 16 may include a plug 20 that interfaces with standard household Alternating Current (AC) electrical outlets. In this regard, the electrical cable 16 includes two wires, a live wire 16a carrying the electrical current, and a neutral wire 16b. The sockets 18 include a positive terminal and a negative terminal, and may be connected to the electrical cable 16 in parallel or in series.

As is well known in the art, the light bulbs 17 and the sockets 18 therefor have standardized sizes. Specifically, according to one preferred embodiment of the present invention, C-9 size light bulbs are used, the “C” denoting the “candle” shape of the “flame,” or bulb portion 19, and the 9 denoting a diameter of 9/8 of an inch, or one and one eighth of an inch. Additionally, the C-7 size light bulb having a diameter of ⅞ of an inch is also used in another preferred embodiment. Due to its smaller size, the C-7 size may be more suitable for areas such as patio covers, fences, block walls, and the like. Other types of light bulbs and sizes may be readily substituted, and the aforementioned types have been presented by way of example only and not of limitation. While particular reference has been made to the sockets 18, it will be understood that it may more generally be referred to as a coupling member, as will become more apparent upon considering alternative accessories that may be used in conjunction with the apparatus 10.

The accessory attachment apparatus 10 is preferably comprised of an integrally formed elongate member 22. The elongate member 22 is defined by a base segment 24, and a pair of opposed first and second coupling segments 26, 28, both of which include first and second gripping portions 30, 32, respectively. More particularly, the base segment 24 has a first lateral edge 25 and a generally opposed second lateral edge 27. The first gripping portion 30 extends from the first lateral edge 25, and the second gripping portion 32 extends from the second lateral edge 27. Preferably, the first and second gripping portions 30, 32 are bent such that the base segment 24 is in a perpendicular relation thereto. Along these lines, it is contemplated that the first and second gripping portions 30, 32 generally extend in parallel relation to each other.

The gripping portions 30, 32 frictionally and releasably engage the socket 18 between the first and second coupling segments 26, 28. The base segment 24, the first coupling segment 26, and the second coupling segment 28 together define a channel 34 with an elongate slit 36 delineated by the gripping portions 30, 32. The elongate member 22 defines an open end 35 into the channel 34, as well as a longitudinal axis 37 that the channel 34 extends along. The open end 35 enables the elongate member 22 to slidably engage accessories therethrough. Alternatively, accessories may be inserted through the slit 36 perpendicularly to the longitudinal axis 37. According to the preferred embodiment, the channel 34 has width W that is greater than width W′ of the slit 36. Alternative configurations where width W is equivalent to that of width W′ are also contemplated, and those having ordinary skill in the art will be able to readily derive such alternatives. To securely and reliably hold the socket 18, the first and second gripping portions 30, 32 may be biased slightly inwards toward the slit 36, thereby imparting a greater frictional force.

In a preferred embodiment, the gripping portions 30, 32 are ridges having particular features. For the purpose of the following, such features will be described only in terms of the first gripping portion 30 for the sake of convenience. It is to be understood, however, that the same features are also present in the second gripping portion 32. The ridge of the first gripping portion 30 is defined by a first ridge section 38 that faces the channel 34, and a second ridge section 40 that faces the exterior of the elongate member 22, separated by an apex 41, the contact point with respect to the socket 18. Preferably, the inverse of the ridge defines a notch 42, the utility of which will be described in further detail below. In this regard, the gripping portion 30 of the first coupling segment 26 generally defines a v-shaped cross section.

As briefly mentioned above, the elongate member 22 is preferably integrally formed, with a length of approximately ten feet (10′). It is contemplated that the elongate member 22 can be cut to fit and size using common tools during the initial installation on the structure 12. Accordingly, it is further contemplated that the elongate member 22 is constructed of flexible, yet rigid material that is resistant to deformation. In this regard, a preferred embodiment of the elongate member 22 is constructed of a twenty-six (26) gauge galvanized metal sheet. In an alternative embodiment, the elongate member 22 is constructed of rigid polyvinyl chloride (PVC). In further detail, the PVC material is weather resistant, and includes pigmentation which resists fading despite exposure to Ultraviolet (UV) rays. A person having ordinary skill in the art will recognize the advantages and disadvantages of these materials as well as any others in any given environment. It follows that such a person will be able identify and select the appropriate material for the particular application, and appreciate that the present invention is not limited to any particular material.

In order to attach the accessory attachment apparatus 10 to the structure 12, the elongate member 22, specifically the base segment 24, includes a series of fastener apertures 44 in a spaced relationship along the same. The fastener apertures 44 are adapted to receive a fastener 46, a shaft portion 48 thereof being driven into the structure 12, and a head portion 50 being in abutment with the base segment 24, thereby retaining the elongate member 22 against the structure 12. As will be appreciated, the diameter of the fastener apertures 44 are intended to be less than that of the head portion 50 of the fastener 46. With respect to the fastener 46, one of ordinary skill in the art will recognize that while it is shown as a screw, any suitable fastener such as nails, rivets, and the like may be substituted.

It will be appreciated that the aforementioned configuration of the elongate member 22 offers numerous advantages over conventional devices. Specifically the individual light bulbs 17 and the sockets 18 mated thereto that comprise the light string 14 may be slid on to the elongate member 22 between the first and second coupling segments 26, 28 without excessive force. The light string 14 may be attached to the elongate member 22 prior to or subsequent to installation of the elongate member 22 on the structure 12. Along these lines, a single pushing movement upon the light bulbs 17 is all that is required to attach the light string 14 to the structure 12, and a single pulling movement upon the light string 14 is all that is required to remove the same from the structure 12. Accordingly, a decorator need not be endangered, particularly when installing the light strings 14 at unsafe heights. Further, the light bulbs 17 may be laterally shifted along the slit 36, both before and after coupling the same to the elongate member 22. As such, the density of the light bulbs 17 may be altered in any desirable location. It will also be recognized that due to the straightness achieved in the manufacture of the elongate member 22, the light bulbs 17 coupled thereto will also be properly aligned along a straight line. An additional benefit of the aforementioned construction of the elongate member 22 is that the electrical cable 16 may be hidden away from view within the channel 34 and behind the ridge as provided in a preferred embodiment of the first and second gripping portions 30, 32.

When the light string 14 is not coupled to the elongate member 22, the accessory attachment apparatus 10 further enhances the decorative appearance of the structure 12 to which it is attached. In particular, the apparatus 10 serves a trim function and imparts a molding effect and dimension to the structure 12. Additionally, the elongate member 22 may be painted a color that contrasts the color of the underlying structure 12, thereby providing further aesthetic improvements. Of course, one of ordinary skill in the art will recognize that proper, well known surface treatments are necessary to retain any such applied paint.

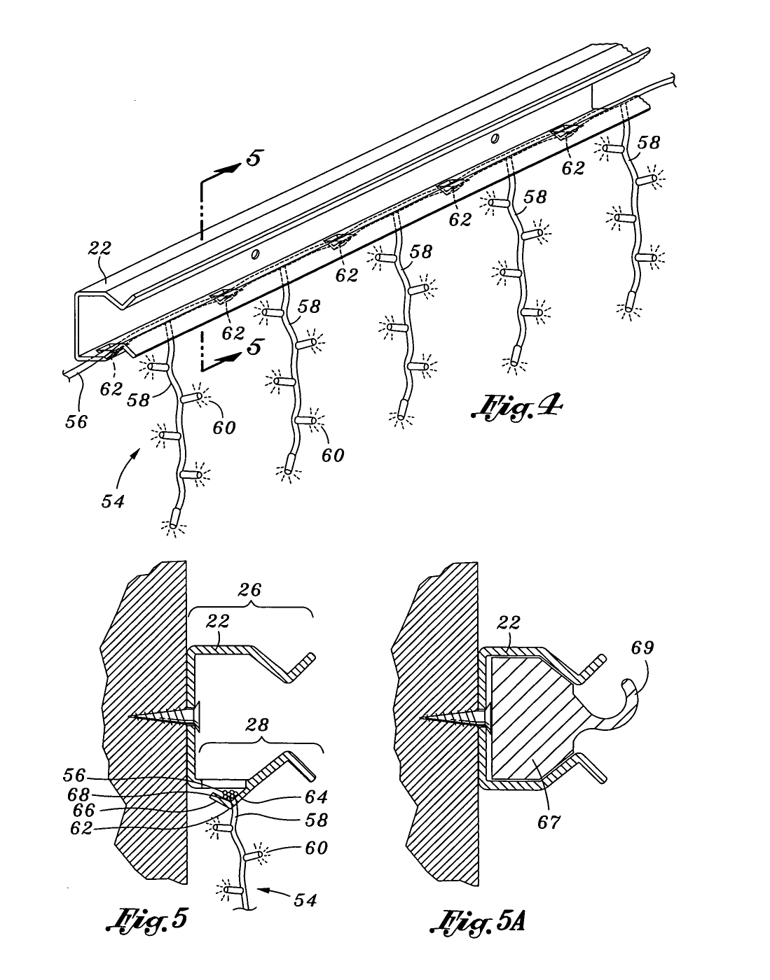

As indicated above, the accessory attachment apparatus 10 is intended to be permanently fixed to the structure 12. Thus, if the elongate member 22 is configured for an accessory having a particular size, it will not be able to otherwise accommodate a second accessory of a different size. According to another aspect of the present invention as illustrated in FIG. 3, there may be provided a second elongate member or secondary insert 49 disposed within the elongate member 22. The second elongate member 49 is configured in substantially the same fashion as was described in relation to the elongate member 22, except for the size thereof. As the second elongate member 49 accommodates a socket 51 having a smaller diameter, a slot 52 is also smaller than defined by the elongate member 22. The elongate member 22 may be fixed to the structure 12 independently of the second elongate member 48 as shown in FIG. 3, where the fastener 46 engages the first elongate member 22. Alternatively, as illustrated in FIG. 3A, the fastener 46 may additionally engage the second elongate member 48, such that both elongate members 46, 48 are permanently fixed to the structure 12.

There are additional accessories which may be coupled to the accessory attachment apparatus 10 as illustrated in FIGS. 4 and 5, such as an icicle light string 54. As is well known in the art, the icicle light string 54 includes a main electrical cable 56, with sub-strands 58 extending therefrom. Each of the sub-strands 58 includes light bulbs 60 connected thereto, simulating an icicle effect as suggested by the name therefor. As a general matter, the light bulbs 60 are of a smaller size than those on the light string 14.

The icicle light string 52 is suspended from a plurality of hooks 62 stamped from the second coupling segment 28. The hooks 62 are disposed along the elongate member 22 in a spaced relationship. As shown in FIG. 5, the hook 62 is also integral with the elongate member 22, and defines a first hook portion 64 and a second hook portion 66, which together define a hook groove 68. The main electrical cable 56 is placed in the hook groove 68. It is understood that the hook 62 is sized and configured to have sufficient strength to hang the icicle light string 54. Suspending the icicle light string 54 from the hook 62 is presented by way of example only and not of limitation. Other accessories may be suspended from the hook 62, such as hanging plants, provided that the strength of the hook 62 is increased by modifying the dimensions thereof. As will be apparent, any hanging accessory such as the aforementioned plant or the icicle light string 54 may be combined with accessories coupled to the first and second coupling segments 26, 28. For example, the light string 14 may also be attached.

In an alternative embodiment shown in FIG. 5A, an insert 67 may be retained within the elongate member 22. Specifically, the insert 67 defines a profile conforming to the internal cross section of the elongate member 22. The insert 67 includes a hook 69, which may be separately attached to the insert 67, or be of unitary construction with the insert 67. As will be appreciated by one of ordinary skill in the art, the hook 69 may be utilized to hang the icicle light string 54, plants, and the like. The length of the insert 67 may span the entire length of the elongate member 22 to which it is inserted, or may be smaller subsections capable of being distributed according to user preference.

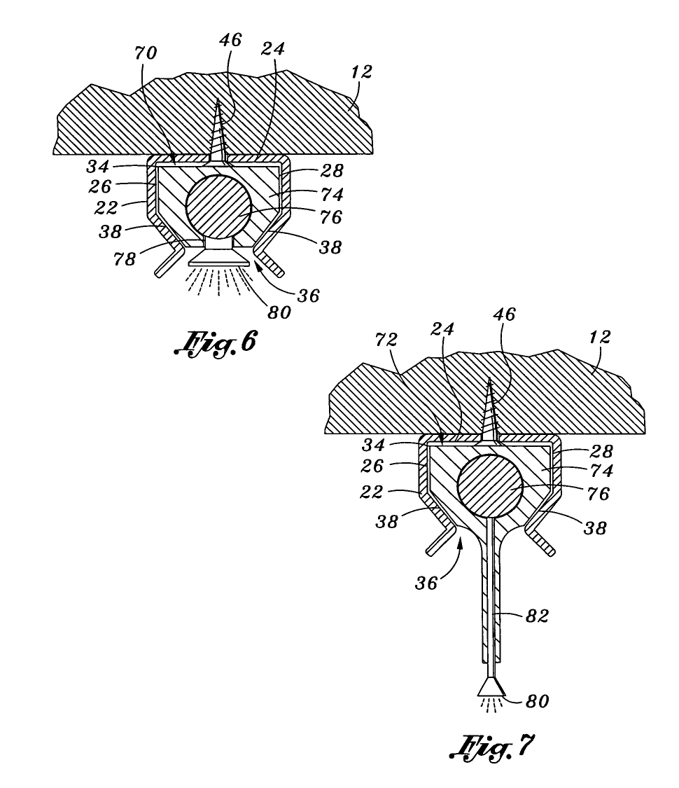

With reference to FIGS. 6 and 7, the elongate member 22 is shown coupled to a first misting apparatus 70, as well as a second misting apparatus 72. Both the first and second misting apparatuses 70, 72 include an elongate housing 74 disposed within the channel 34. The housing 74 has an outer contour that matches the internal contour of the elongate member 22, specifically that as defined by the first and second coupling segments 26, 28, and the base segment 24. It is contemplated that the first and second misting apparatuses 70, 72 are inserted into the elongate member 22 from the open ends thereof, and prevented from dropping through the slit 36 by the first ridge section 38 of the elongate member 22.

The housing 74 encloses a main line 76, which is a tubular member connected to a pressurized water source. FIG. 6 illustrates the misting apparatus 70 having at least one first connecting tube 78 that extends within the elongate member 22 and in fluid communication with the main line 76. The first misting apparatus 70 includes a bell-shaped nozzle or emitter 80 in fluid communication with the first connecting tube 78. As will be appreciated by one of ordinary skill in the art, the nozzle or emitter 80 may be variously configured to fulfill various functions, including misting as mentioned above, as well as dripping water onto plants, vegetation, and the like. In this regard, it is understood that the volume of fluid expelled may be modified by adjusting the configuration of the nozzle 80. FIG. 7 illustrates the second misting apparatus 72 having at least one second connecting tube 82 extending beyond the elongate member 22 and in fluid communication with the main line 76. As present in the first misting apparatus 70, the second misting apparatus 72 includes the bell-shaped nozzle 80. One of ordinary skill in the art will recognize the specific implementation of the misting apparatuses 70, 72, as well as the principles that govern operation. In this regard, alternative misting systems may be substituted without departing from the scope of the present invention.

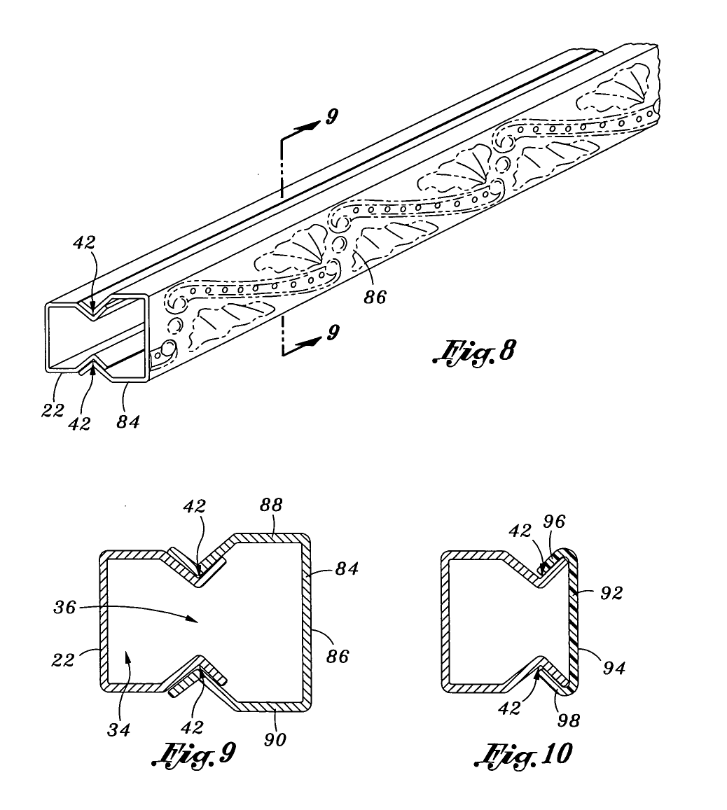

As briefly discussed hereinabove, the accessory attachment apparatus 10 in accordance with the present invention is envisioned to provide additional decorative enhancements to the structure 12. Another accessory is expressly contemplated for this purpose, as illustrated in FIGS. 8, 9, and 10. In a first preferred embodiment, a cover 84 is coupled to the elongate member 22 to conceal the channel 34 and the slit 36. The cover 84 may include a front face 86 adorned with ornamental features, and a pair of opposed legs 88 and 90. The legs 88, 90, like the first and second coupling segments 26, 28 of the elongate member 22, have portions which define a v-shaped cross section. This portion is engaged to the notch 42 on the elongate member 22, and forms an interlocking relationship. In a second preferred embodiment, a cover 92 likewise defines a front face 94, and alternatively, inward folds 96, 98. The inward folds 96, 98 are thus engaged to the notch 42 and similarly form an interlocking relationship thereto. As shown in FIGS. 9 and 10, the degree to which the first embodiment of the cover 84 must bend to disengage from the elongate member 22 is less than the degree to which the second embodiment of the cover 92 must bend to disengage from the elongate member 22. As such, the cover 84 may prove to be easier to remove than the cover 92. However, like other aforementioned accessories, both covers 84, 92 are adapted to laterally slide off of the elongate member 22. Like the elongate member 22 to which it is coupled, the covers 84, 92 may be constructed of any suitable flexible yet rigid material such as 26 gauge metal or PVC as indicated above.

It will be apparent to those having ordinary skill in the art that the particular accessories coupled to the elongate member 22 are presented by way of example only and not of limitation. Such a person will be able to readily derive additional accessories suitable for coupling to the structure 12 via the accessory attachment apparatus 10. Any such accessory is therefore deemed to be within the scope of the present invention.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A device for removably mounting to a structure an accessory having a coupling member of a first size, the device comprising:
an elongate member defining a base segment and a pair of opposed, resilient coupling segments, the coupling segments each including a gripping portion for frictionally and releasably engaging the coupling member of the accessory therebetween.

2. The device of claim 1, wherein the base segment and the pair of coupling segments define a channel therebetween, the channel extending along a longitudinal axis of the elongate member.

3. The device of claim 2, wherein the elongate member defines an open end of the channel for engagement of the accessory therethrough.

4. The device of claim 2, wherein the accessory is slidably insertable within the channel along an axis parallel to the longitudinal axis of the elongate member.

4. The device of claim 2, wherein the elongate member receives the accessory along an axis perpendicular to the longitudinal axis of the elongate member.

5. The device of claim 1, wherein a first one of the coupling segments and a second one of the coupling segments extends from the base segment.

6. The device of claim 5, wherein the base segment defines a first lateral edge and a second lateral edge, the first one of the coupling segments extending from the first lateral edge and the second one of the coupling segments extending from the second lateral edge.

7. The device of claim 1, further comprising a cover engageable to the first and second coupling segments on the elongate member.

8. The device of claim 7, wherein the first and second coupling segments each define a notch to which the cover is engageable.

9. The device of claim 7, wherein the cover is slidably engageable to the coupling segments along an exterior surface thereof.

10. The device of claim 7, wherein the cover is resiliently deformable for frictional engagement to the elongate member.

11. The device of claim 7, wherein the coupling segments of the elongate member are resiliently deformable for frictional engagement to the cover.

12. The device of claim 1, wherein the base segment defines a plurality of fastener apertures for receiving a fastener to fix the first elongate member to the structure.

13. The device of claim 1, further comprising a secondary adapter disposed within the elongate member, the secondary adapter being defined by an adapter base and a pair of opposed adapter arms conforming to the contour of the coupling segments of the elongate member.

14. The device of claim 13, wherein the secondary adapter and the elongate member are coupled to the structure with fasteners.

15. A rail mounting structure for detachably engaging at least one accessory along the length thereof, the structure comprising:
an elongate rail member having a substantially U-shaped cross section defining a channel formed of a base section and a pair of opposing sidewalls extending therefrom, the sidewalls each having an inwardly extending portion for frictionally engaging the accessory therebetween.

16. The rail mounting structure of claim 15, further comprising a plurality of accessories engaged to the rail member, the accessories being slidably translatable along the length of the channel.

17. The rail mounting structure of claim 16, wherein the accessories comprise a string of interconnected light fixtures.

18. The rail mounting structure of claim 16, wherein the accessory comprises a fluid conduit, the fluid conduit defining a plurality of fluid distribution apertures formed along the length of the conduit.

19. The rail mounting structure of claim 18, wherein the rail member defines a first end portion, the fluid conduit being slidably insertable therein.

20. The rail mounting structure of claim 15, wherein the inwardly extending portions define protrusions extending from the sidewalls within the channel.

21. The rail mounting structure of claim 20, wherein the protrusions extend substantially along the length of the channel.

22. The rail mounting structure of claim 15, wherein the sidewalls define a notch extending into the channel.

23. The rail mounting structure of claim 22, wherein the notch extends substantially along the length of the channel.

24. The rail mounting structure of claim 15, wherein the sidewalls are deformable to receive and engage an accessory in response to insertion of the accessory into the channel.

25. An accessory mounting device comprising:
an elongate rail of unitary construction defining an internal conduit bounded by a rear wall, a first leg, and a second leg, the first and second legs each including an accessory engagement portion.

26. The device of claim 25, wherein the accessory engagement portion defines a truncated V-shaped cross section.

27. The device of claim 25, wherein the accessory is a light string with a plurality of light bulbs mated to sockets of the C7 size.

29. The device of claim 25, wherein the accessory is a light string with a plurality of light bulbs mated to sockets of the C9 size.

30. The device of claim 25, wherein the accessory is a misting apparatus including a main line extending through the internal conduit and in fluid communication with a pressurized water source, the main line being in fluid communication with a plurality of mist nozzles via connecting tubes.

31. The device of claim 25, further comprising a plurality of hooks extending from the first leg in a spaced relationship.

32. The device of claim 25, further comprising a hook insert having an elongate main body with a cross section substantially contoured to that of the internal conduit, and a hook extending from the main body.

33. A decorative lighting assembly for providing an illumination effect to a building, the assembly comprising:
a light string having a plurality of light bulbs mated to electrically interconnected sockets; and
an elongate member having a trough defined by a pair of opposed coupling elements for frictional engagement of the sockets, at least a portion of the coupling elements defining a truncated v-shaped cross section.

34. The decorative lighting assembly of claim 33, wherein the coupling elements are adapted to receive and slidably engage at least one socket of the light string.

35. The decorative lighting assembly of claim 33, wherein the sockets are spaced along a wire engageable to a power source, the wire being hidden behind the coupling element inside the trough.

36. The decorative lighting assembly of claim 33, wherein the coupling elements are biased toward each other, thereby increasing the gripping force upon the socket.

37. The decorative lighting assembly of claim 33, wherein the elongate member is constructed of material that can be cut to vary the length thereof.

38. A misting assembly for supplying hydration to areas surrounding a structure, the assembly comprising:
a mister comprising:
a main line in fluid communication with a source;
a nozzle in fluid communication with the main line; and
an enclosure housing the main line, the enclosure defining an access port through which the nozzle extends from the main line; and
an elongate member having a trough defined by a pair of opposed coupling elements for frictional engagement of the mister, at least a portion of the coupling elements defining a truncated v-shaped cross section.

39. The misting assembly of claim 38, wherein the enclosure of the mister defines a cross section corresponding to the trough, the mister being retained therein.
